(19) United States
(12) Patent Application Publication
(10) Pub. No.: US 2017/0085623 A1
(43) Pub. Date: Mar. 23, 2017

(54) CONTENT DOWNLOADING AND NETWORK PROVISIONING

(71) Applicant: Orange, Paris (FR)

(72) Inventors: Patrice Houze, Rennes (FR); Emmanuel Mory, Betton (FR)

(21) Appl. No.: 15/311,479

(22) PCT Filed: May 19, 2015
(86) PCT No.: PCT/FR2015/051311

§ 371 Date: Nov. 15, 2016

(30) Foreign Application Priority Data
May 26, 2014 (FR) 1454741

(51) Int. Cl. H04L 29/08; H04L 29/06; H04L 12/26

(52) U.S. Cl. CPC H04L 67/06; H04L 67/141; H04L 43/0894; H04L 67/1061; H04L 69/14; H04L 67/42

(57) ABSTRACT

Some embodiments relate to a method for downloading content to a first terminal from a server. The first terminal may intercept a request to download content previously sent by the first terminal to the server, discover a second terminal connected to the terminal via a local network, and receive from the second terminal a message offering to share a wide-area telecommunications network, the message containing an identifier of a port associated with the second terminal. The first terminal may determine at least one data segment of the content to be downloaded depending on the offer of sharing, establish communication and transmit, via the local network, to the port of the second terminal, a request to download the determined segment, receive from the second terminal the segment, which has previously been obtained by the second terminal following connection of the second terminal to the server via the wide area network.

### FIELD OF THE INVENTION

The field of the invention is that of processing multimedia content.

Multimedia content is understood to mean any audio and/or visual content, or more generally any other digital content.

The invention more specifically concerns the transmission and reception of such multimedia content, particularly the continuous download thereof, also called streaming.

It applies particularly to any client terminal (subsequently called simply terminal) that is capable of communicating on a wide area telecommunications network in order to access a multimedia content via a universal address, also called URI (Uniform Resource Identifier).

### PRESENTATION OF THE PRIOR ART

Access to a content of the aforementioned type from a terminal is triggered generally by a request through a URI address of the content. Such access uses the HTTP (Hyper Text Transport Protocol) protocol, for example, which is a client/server communication protocol developed for wide area telecommunications networks, such as the Internet and particularly the web.

Once the communication has been set up between the terminal and the server according to the aforementioned HTTP protocol, a content download application installed in the terminal sets up a communication with the server for the purpose of the content download, according to a predetermined communication protocol, such as particularly the TCP (Transmission Control Protocol) protocol. In a manner known per se, the TCP protocol allows control of the state of the transmission of the data of the content requested between the server and the terminal.

A network of Internet type provides a link between the terminal and the server that benefits from a bandwidth associated with a determined data transmission bit rate. Such a bit rate is limited to a predetermined value that is dependent on the type of subscription to the Internet network to which the user of the terminal has subscribed.

Such a bit rate can prove insufficient for some data transfer operations, particularly when the terminal requests download of a content of the aforementioned type whose data volume is high. This results in a waiting time that is sometimes prohibitive for download or in failure of said download.

The document “Improving TCP Performance over Wireless Networks with Collaborative Multi-Homed Mobile Hosts”, Kyu-Han Kim and Kang G. Shin, describes a solution that allows this problem to be overcome. To this end, a terminal requesting a content from a server, via an Internet network, is offered the benefit of all or some of the bandwidth of multiple terminals connected to one another on one and the same local area telecommunications network. These terminals connect to the server via a proxy module installed on the Internet network that is responsible for managing the connections between each of the terminals and the server.

A disadvantage of such a solution is that it requires physical modification of the Internet network. It is therefore expensive. Moreover, it is very difficult to adapt.

Indeed, the operator intervenes on its network in order to meet a local need of one or more clients. If this need disappears and a new need appears on another area of the network, then another intervention is necessary.

### SUBJECT AND SUMMARY OF THE INVENTION

One of the aims of the invention is to overcome disadvantages of the aforementioned prior art.

To this end, a subject of the present invention concerns a method for downloading content into a first terminal from a server, via a first wide area telecommunications network, comprising a step of setting up a first communication from the first terminal, according to a predetermined communication protocol, in the course of which the first terminal transmits a download request for a content to the server, via the first wide area telecommunications network.

Such a method is remarkable in that it comprises, on the first terminal, the following steps:
intercepting the content download request,
discovering at least one second terminal connected to the first terminal via a local area telecommunications network, the second terminal being moreover connected to a second wide area telecommunications network, in the course of which the first terminal:
   sends to the second terminal a message that contains identification information for the server,
   receives from the second terminal a message offering to share the second wide area telecommunications network, for the purpose of the content download, the message offering to share containing a port identifier associated with the second terminal,
determining at least one first data segment of the content to be downloaded on the basis of the offer to share contained in the received message,
setting up a second communication from the first terminal, according to the predetermined communication protocol, in the course of which the first terminal, via the local area telecommunications network:
   transmits to the port associated with the second terminal a download request for the determined first content segment,
   receives from the second terminal the first content segment that has been obtained previously by the second terminal following a connection by the latter to the server, via the second wide area telecommunications network, by means of the identification information for the server that was sent by the first terminal in the discovery step.

Such a provision has the advantage of allowing a terminal requesting download of a content from a server and visible to another terminal, via a common local area telecommunications network, to simply ask this other terminal for an offer to contribute to the available bandwidth on the wide area telecommunications network to which this other terminal is connected, in order to access such a content.

The wide area telecommunications networks to which the two visible terminals are respectively connected are of Internet type, for example, and are of both fixed type (for example ADSL) and mobile type (for example 3G, 4G).

To this end, the two terminals are previously configured to each contain a common dedicated protocol layer. In the case of the OSI (Open Systems Interconnection) model, for example, such a dedicated protocol layer could come in between protocol layer 4 and protocol layer 5, for example, in order to allow the terminal requesting download of a content to implement the aforementioned steps of intercepting the content download request, discovering the neighboring terminals, determining at least one first data segment of the content to be downloaded and setting up a communication with the server, via at least one neighboring terminal, and to use this communication to receive, via the neighboring terminal, the first data segment of the content.

The invention thus allows the technical problem of providing additional bandwidth for a terminal requesting download of a content to be solved in a manner that is flexible and appropriate to its needs.

Moreover, the invention advantageously allows there to be no need for physical intervention by the operator and there to be no entailing of particular modifications on the content servers.

According to one particular embodiment, the message offering to share received in the discovery step moreover contains:
the type to which the second wide area telecommunications network belongs,
the address of a device for the second terminal to access the second wide area telecommunications network,
the bandwidth offered by the second terminal.

Such a provision allows the terminal having requested download of a content to precisely identify the contributing terminal so that the dedicated protocol layer of the requesting terminal is able to determine what data segment(s) of the content to be downloaded it is possible to request from this contributing terminal.

In this regard, the requesting terminal needs to know the bandwidth offered by the contributing terminal, and the address of the access device of this second terminal, so as to be able to direct to the latter its content segment download request(s).

The requesting terminal also needs to check the bandwidth contribution offer transmitted by the contributing terminal to determine that the latter is not connected to the same wide area telecommunications network as the requesting terminal. Indeed, the cooperation of a contributing terminal under consideration via a local area telecommunications network (for example WiFi) common to the terminal requesting the content download is of no real interest unless the type of wide area telecommunications network to which the contributing terminal is connected is different than that to which the requesting terminal is connected.

The step of intercepting the download request consists in:
determining whether the content to be downloaded can be broken down into at least one first data segment,
in the event of the response being positive, transmitting a discovery request from one or more connected terminals to the first terminal via the local area telecommunications network,
in the event of the response being negative:
   continuing transmission of the content download request to said server,
   receiving the content from the server.

Such a provision allows the requesting terminal, on its dedicated protocol layer, to intercept the content download request in order to check whether said request can be divided into multiple different and independent requests that are capable of being sent to respective different contributing terminals. To this end, the dedicated protocol layer checks that the content for which the download is requested can be broken down into multiple data segments. If this is the case, then the engagement of the contributing neighboring terminals is started. Otherwise, a conventional download of the content directly from the server is started.

According to yet another particular embodiment, in the event of the first terminal determining that the content to be downloaded comprises a second data segment and that the bandwidth of the first terminal is sufficient to allow download of the second segment directly from the server, the following steps are performed:
setting up a third communication from the first terminal, according to the predetermined communication protocol, in the course of which the first terminal, via the first wide area telecommunications network:
   transmits to the server a download request for the second content segment,
   receives the second content segment from the server.

Such a provision is implemented if the content asked for by the requesting terminal can be broken down into at least two data segments and the requesting terminal has a sufficient bandwidth on its wide area telecommunications network to download at least one of the two data segments of the content, directly from the server.

According to yet another particular embodiment, following reception of the first and second segments, the following steps are performed, on the first terminal:
aggregating the first and second segments in a predetermined order,
receiving the aggregated first and second segments in response to the download request for a content, transmitted in the course of the first communication set up by the first terminal.

Such a provision allows the dedicated protocol layer of the terminal that has requested the content download to aggregate the received data segments both directly from the content server and from the contributing terminal, and then to reorder these segments for the purpose of downloading them into the requesting terminal.

According to yet another particular embodiment, the following steps are performed:
discovering at least one third terminal connected to the first terminal via the local area telecommunications network, the third terminal being moreover connected to a third wide area telecommunications network, in the course of which the first terminal:
   sends to the third terminal a message that contains identification information for the server,
   receives from the third terminal a message offering to share the third wide area communication network, for the purpose of the content download, the message containing a port identifier associated with the third terminal,
determining at least one third data segment of the content to be downloaded on the basis of the offer to share contained in the received message,
setting up a fourth communication from the first terminal, according to the predetermined communication protocol, in the course of which the first terminal, via the local area telecommunications network:
   transmits to the port associated with the third terminal a download request for the determined third content segment,
   receives from the third terminal the third content segment, which has been obtained previously by the third terminal following a connection by the latter to the server, via the third wide area telecommunications network, by means of the identification information for the server that was sent by the first terminal in the discovery step.

Such a provision has an embodiment in which two neighboring terminals for the terminal that has requested the content download are contributive.

According to yet another particular embodiment, following reception of the first, second and third segments, the following steps are performed, on the first terminal:
aggregating the first, second and third segments in a predetermined order,
receiving the aggregated first, second and third segments, in response to the content download request transmitted in the course of the first communication set up by the first terminal.

Such a provision allows the dedicated protocol layer of the terminal that has requested the content download to aggregate all of the data segments received both directly from the content server and from the various contributing terminals, and then to reorder these segments for the purpose of downloading them into the requesting terminal.

The aforementioned various embodiments or implementation features can be added independently or in combination with one another to the steps of the download method defined above.

The invention also concerns a terminal capable of downloading a content from a server, via a first wide area telecommunications network, comprising a module for setting up a first communication according to a predetermined communication protocol that is capable of transmitting a download request for a content to the aforementioned server, via the first wide area telecommunications network. Such a terminal is particularly adapted to implement the aforementioned download method.

The terminal according to the invention is remarkable in that it comprises:
an interception module that is capable of intercepting the content download request,
a module for discovering at least one second terminal connected firstly to the first terminal via a local area telecommunications network and, secondly, to a second wide area telecommunications network, the discovery module being adapted to:
   send to the second terminal a message that contains identification information for the server,
   receive from the second terminal a message offering to share the second wide area telecommunications network, for the purpose of said content download, the message offering to share containing a port identifier associated with the second terminal,
a determination module that is capable of determining at least one first data segment of the content to be downloaded on the basis of the offer to share contained in the received message,
a module for setting up a second communication from the first terminal, according to the predetermined communication protocol, the module for setting up a second communication being adapted to, via the local area telecommunications network:
   transmit to the port associated with the second terminal a download request for the determined first content segment,
   receive from the second terminal the first content segment that has been obtained previously by the second terminal following a connection by the latter to the server, via the second wide area telecommunications network, by means of the identification information for the server that was sent by the discovery module.

The invention also concerns a method for providing a first terminal, connected to a first wide area telecommunications network, with a second wide area telecommunications network to which a second terminal is connected, for the purpose of downloading a content into the first terminal from a server.

Such a method is remarkable in that it comprises, on the second terminal, the following steps:
discovering a connection from the second terminal to the first terminal via a local area telecommunications network, in the course of which the second terminal:
   receives, from the first terminal, a message containing identification information for the server,
   transmits to the first terminal a response to the received message that contains an offer to share the second wide area telecommunications network for the purpose of the content download, such a response containing a port identifier associated with the second terminal,
setting up a communication between the first and second terminals, in the course of which the second terminal:
   receives on said port, from the first terminal, via the local area telecommunications network, a download request for a first content segment determined beforehand by the first terminal from the offer to share,
   takes the received identification information for the server as a basis for routing to the server, via the second wide area telecommunications network, the received download request for the first segment,
   receives in response the first content segment from the server, via the second wide area telecommunications network,
   transmits the received first content segment to the first terminal, via the local area telecommunications network.

Such a provision has the advantage of allowing a terminal that is visible, via a local area telecommunications network common to another terminal having previously requested the download of a content from a server, to simply provide this other terminal with an offer to contribute the available bandwidth on the wide area telecommunications network to which the contributing terminal is connected, so that the requesting terminal can access such a content.

The wide area telecommunications networks to which the two visible terminals are respectively connected are of Internet type, for example, and are of both fixed type (for example ADSL) and mobile type (for example 3G, 4G).

To this end, the two terminals are previously configured to each contain a common dedicated protocol layer. In the case of the OSI (Open Systems Interconnection) model, for example, such a protocol layer could come in between protocol layer 4 and protocol layer 5, for example, in order to allow the terminal contributing bandwidth to implement the aforementioned steps of discovering a connection to the requesting terminal and setting up a communication with the requesting terminal, and to use this communication in order to retransmit, to the requesting terminal, the first data segment of the content that the contributing terminal has obtained from the server.

Thus, the dedicated protocol layer of the contributing terminal advantageously allows it to route to the server the content segment download requests sent by the requesting terminal, without itself setting up a new connection to the server. In other words, the contributing terminal constitutes an IP (Internet Protocol) relay that ensures an NAT (Network Address Translation) function in order to retransmit the download requests to the server and, conversely, retransmit the responses from the server to the requesting terminal.

According to one particular embodiment, the response containing the offer to share the second wide area telecommunications network moreover contains:
the type to which the second wide area telecommunications network belongs,
the address of a device for the second terminal to access the second wide area telecommunications network,
the bandwidth offered by the second terminal.

Such a provision allows the terminal requesting download of a content to precisely identify the contributing terminal so as to be able to send it the content segment download request(s).

Such a provision also allows the requesting terminal to check that the contributing terminal is not connected to the same wide area telecommunications network as the requesting terminal.

The invention also concerns a terminal capable of providing another terminal connected to a first wide area telecommunications network with a second wide area telecommunications network to which the terminal is connected, for the purpose of downloading a content into the other terminal from a server. Such a terminal is particularly adapted to implement the aforementioned method for engaging a wide area telecommunications network.

The terminal according to the invention is remarkable in that it comprises:
a module for discovering a connection from the terminal to the other terminal, via a local area telecommunications network, the discovery module being adapted to:
   receive, from the other terminal, a discovery request for at least one terminal connected to the other terminal via a local area telecommunications network, said request containing identification information for the server,
   transmit to the other terminal, via the local area telecommunications network, a response to the discovery request that contains an offer to share the second wide area telecommunications network, for the purpose of the content download, the response containing a port identifier associated with the aforementioned terminal,
a module for setting up a communication between the two terminals, the module for setting up communication being suited to:
   receive on the port of the terminal, from the other terminal, via the local area telecommunications network, a download request for a first content segment determined beforehand by the other terminal from the offer to share,
   take the received identification information for the server as a basis for routing to the server, via the second wide area telecommunications network, the received download request for the first segment,
   receive in response the first content segment from the server, via the second wide area telecommunications network,
   transmit the received first content segment to the other terminal, via the local area telecommunications network.

Taking account of the fact that the invention is implemented only if the terminal requesting the content download and the contributing terminal each contain a common additional protocol layer:
the terminal requesting the content download is also adapted to be a contributing terminal,
the contributing terminal is also adapted to request download of a content.

The invention also concerns a computer program having instructions for implementing the method for downloading content according to the invention when it is executed on a terminal or more generally on a computer.

The invention also concerns a computer program having instructions for implementing the method for engaging a wide area telecommunications network according to the invention when it is executed on a terminal or more generally on a computer.

Each of these programs can use any programming language, and be in the form of source code, object code or intermediate code between source code and object code, such as in a partially compiled form, or in any other desirable form.

The invention also relates to a computer readable recording medium on which a computer program is recorded, this program having instructions adapted to implement the method for downloading content or the method for engaging a wide area telecommunications network according to the invention, as described above.

Such a recording medium may be any entity or device that is capable of storing the program. By way of example, the medium may have a storage means, such as a ROM, for example a CD-ROM, or a microelectronic circuit ROM, or else a magnetic recording means, for example a USB key or a hard disk.

Moreover, such a recording medium may be a transmittable medium such as an electrical or optical signal, which can be conveyed via an electrical or optical cable, by radio or by other means. The program according to the invention may be downloaded on a network of Internet type, in particular.

Alternatively, the recording medium may be an integrated circuit that incorporates the program, the circuit being adapted to execute or to be used in the execution of the aforementioned access method.

### LIST OF FIGURES

Other advantages and features of the invention will emerge more clearly upon reading the description that follows for multiple particular embodiments of the invention, which are provided by way of simple illustrative and non-limiting examples, and the appended drawings, among which:

FIG. 1 schematically presents a streaming architecture in which the method for downloading content and the method for engaging bandwidth according to a first embodiment of the invention are implemented;

FIG. 2 presents the simplified structure of a terminal requesting download of a content according to an embodiment of the invention;

FIG. 3 presents the simplified structure of a terminal engaging its wide area telecommunications network according to an embodiment of the invention;

FIG. 4A schematically presents the main steps of a method for downloading content according to a first embodiment of the invention;

FIG. 4B schematically presents a first implementation detail for the method of FIG. 4A;

FIG. 4C schematically presents a second implementation detail for the method of FIG. 4A;

FIG. 5 schematically presents the main steps of a method for downloading content according to a second embodiment of the invention;

FIG. 6 schematically presents the main steps of a method for providing a wide area telecommunications network according to an embodiment of the invention;

FIG. 7 schematically presents a streaming architecture in which the method for downloading content and the method for engaging bandwidth according to a second embodiment of the invention are implemented;

FIG. 8 schematically presents a diagram of the interchanges between the various terminals and the server of the architecture of FIG. 7 in order to implement the method for downloading content and the method for engaging bandwidth according to the invention.

### DESCRIPTION OF A PARTICULAR EMBODIMENT OF THE INVENTION

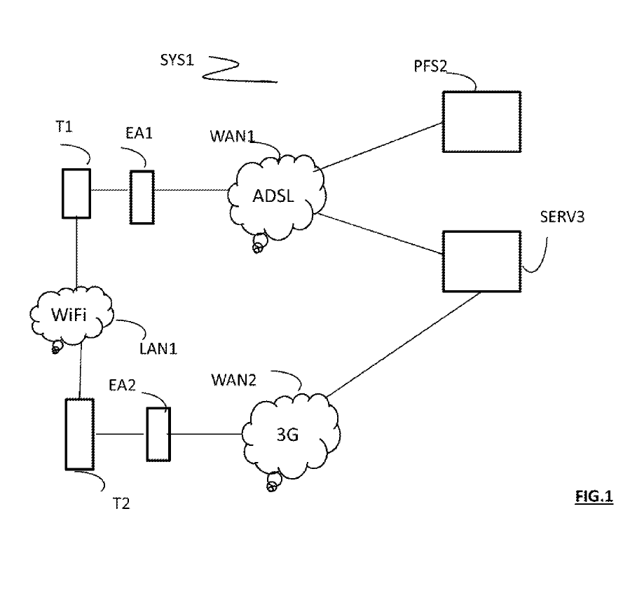

In connection with FIG. 1, an architecture is presented in which the method for downloading content according to the invention and the method for providing a wide area telecommunications network according to the invention are implemented.

Such an architecture presents itself in the form of a computer system SYS1 comprising a client terminal T1, a service platform PFS2 to which the user of the terminal T1 is subscribed, and a content server SERV3. The content server SERV3 is capable of providing the terminal T1 with a content in response to a request from said terminal, the provision of such a content being managed by the service platform PFS2.

In the example represented in FIG. 1, the terminal T1, the platform PFS2 and the server SERV3 communicate with one another via a first wide area telecommunications network WAN1, for example of IP (Internal Protocol) type. In the example represented, the network WAN1 is of fixed and more particularly ADSL (Asymmetric Digital Subscriber Line) type. The terminal T1 is connected to the network WAN1 by means of an access device EA1, such as a home or company gateway, for example.

The service platform PFS2 provides the user of the terminal T1 with various types of content, such as, by way of example:
television content TV, particularly that for programmed broadcast in a program schedule,
VOD (Video On Demand) catalogs,
catalogs of videos and/or images and/or photographs,
catalogs of music or podcasts,
catalogs of digital books,
catalogs of applications and/or services.

Depending on the services provided by the platform PFS2, the aforementioned content can be previously broken down into a plurality of temporal data segments respectively coded according to various possible coding profiles. Such breakdown and coding operations are implemented in a dedicated device, not shown, that is connected to the content server SERV3.

The terminal T1 is also connected to a local area telecommunications network LAN1 that conventionally uses short range wireless connection means, for example of WiFi type, or even wired connection means, for example of powerline type CPL.

The terminal T1 is moreover connected to a terminal T2 via the local area telecommunications network LAN1. The terminal T2, for its part, is adapted to communicate with the server SERV3 via a second wide area telecommunications network WAN2, such as for example of IP type. In the example represented, the network WAN2 is of mobile and more particularly 3G type. The terminal T2 is connected to the network WAN2 by means of an access device EA2, such as a home or company gateway, for example.

In the example represented, the architecture chosen to illustrate the invention is what is known as a streaming architecture based on the use of the HTTP protocol. Conventionally, the client terminal T1 wishes to start communicating with the content server SERV3 in order to download a multimedia content made up of one or more media (audio, video, etc.).

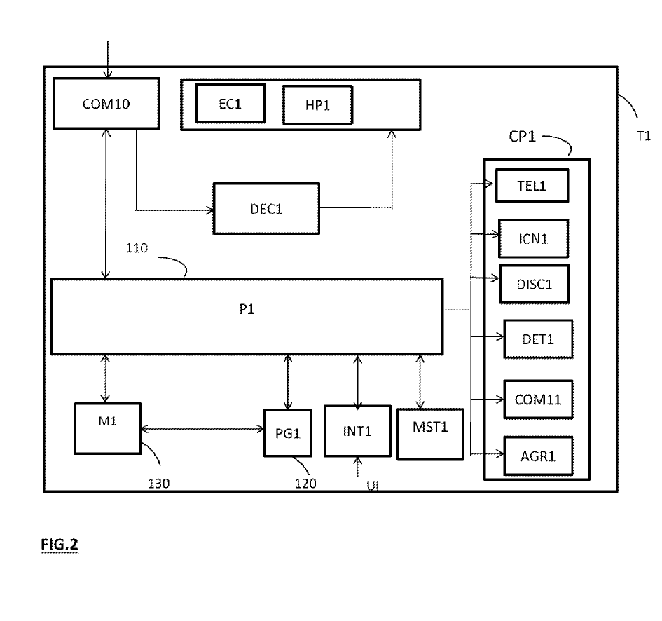

In connection with FIG. 2, the simplified structure of the terminal T1 for downloading content, according to an exemplary embodiment of the invention, will now be considered. Such a terminal is adapted to implement the method for downloading content according to the invention that will be described below.

By way of example, the terminal T1 is a portable computer or even a cellphone, a Smartphone, a tablet, etc.

In the example represented in FIG. 2, the terminal T1 comprises physical and/or software resources, particularly a processing unit 110, for example equipped with a processor P1, and controlled by a computer program PG1 120, stored in a memory M1 130 and implementing the method for downloading content according to the invention. The terminal T1 conventionally comprises a communication module COM10 that operates according to a predetermined communication protocol, such as particularly the TCP protocol, and that is adapted to:
transmit from the terminal T1 and to the server SERV3 of FIG. 1, via the network WAN1 of FIG. 1, a content download request,
receive in response from the server SERV3, via the network WAN1, the requested content.

On initialization, the code instructions of the computer program PG1 120 are loaded into a RAM store (not shown), for example, before being executed by the processor P1 of the processing unit 110. The processor of the processing unit 110 implements the steps of the method for downloading content that will be described below, according to the instructions of the computer program 120.

In a manner that is known as such, the terminal T1 also comprises:
a module INT1 for processing user interactions UI,
a visual display screen EC1,
a loudspeaker HP1,
an interface DEC1 for audio/video decoding of content of text, audio, video or audiovisual type, said interface being adapted to transmit the decoded signals to the screen EC1 or to the loudspeaker HP1,
a temporary storage memory MST1,
a module TEL1 for downloading content.

According to the invention, the terminal T1 moreover comprises:
an interception module ICN1 capable of intercepting a content download request transmitted by the communication module COM10 of the terminal T1,
a discovery module DISC1 capable of discovering the terminal T2 represented in FIG. 1, in the local area telecommunications network LAN1 that is also represented in FIG. 1,
a determination module DET1 capable of determining at least one data segment of the content to be downloaded,
a module COM11 for setting up a communication from the terminal T1, according to the predetermined communication protocol TCP, said module COM11 allowing the terminal T1 to send a download request for the determined data segment, via the local area telecommunications network LAN1, to the terminal T2,
a module AGR1 for aggregating content data segments.

The modules ICN1, DISC1, DET1, COM11 and AGR1, which will be described in more detail in the description that follows, are controlled by the processor P1 of the processing unit 110.

According to an exemplary embodiment, the modules ICN1, DISC1, DET1, COM11 and AGR1 are advantageously gathered together within a new protocol layer CP1 of the OSI model that is situated preferably between “transport” layer No. 4 and “session” layer No. 5.

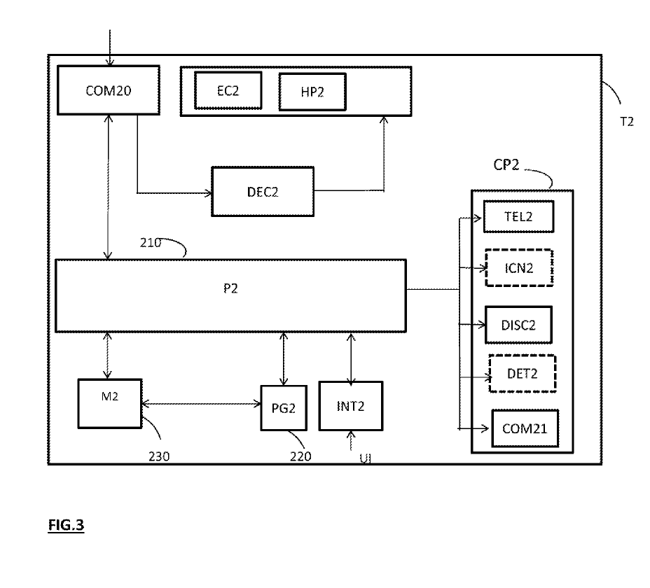

In connection with FIG. 3, the simplified structure of the terminal T2 represented in FIG. 1, according to an exemplary embodiment of the invention, will now be considered. Such a terminal is adapted to implement the method according to the invention that will be described below and that is intended to implement the engagement of the wide area telecommunications network to which the terminal T2 is connected.

By way of example, the terminal T2 is a portable computer or even a cellphone, a Smartphone, a tablet, etc.

In the example represented in FIG. 3, the terminal T2 comprises physical and/or software resources, particularly a processing unit 210, for example equipped with a processor P2, and controlled by a computer program PG2 220, stored in a memory M2 230 and implementing the method for engaging a wide area telecommunications network according to the invention. The terminal T2 conventionally comprises a communication module COM20 that operates according to a predetermined communication protocol, such as particularly the TCP protocol, and that is adapted to set up communications, via the network WAN2 of FIG. 1, with particularly the server SERV3 of FIG. 1.

On initialization, the code instructions of the computer program PG2 220 are loaded into a RAM store (not shown), for example, before being executed by the processor P2 of the processing unit 210. The processor of the processing unit 210 implements the steps of the method for engaging a wide area telecommunications network that will be described below, according to the instructions of the computer program 220.

In a manner that is known as such, the terminal T2 also comprises:
a module INT2 for processing user interactions UI,
a visual display screen EC2,
a loudspeaker HP2,
an interface DEC2 for audio/video decoding of content of text, audio, video or audiovisual type, said interface being adapted to transmit the decoded signals to the screen EC2 or to the loudspeaker HP2,
a module TEL2 for downloading content.

According to the invention, the terminal T2 moreover comprises:
a discovery module DISC2 capable of discovering the terminal T1 represented in FIG. 1, in the local area telecommunications network LAN1 that is also represented in FIG. 1,
a communication module COM21 operating according to the predetermined communication protocol TCP, via the local area telecommunications network LAN1, and allowing the terminal T2 to receive from the terminal T1, via the network LAN1, a download request for a determined data segment of the content to be downloaded.

The modules DISC2 and COM21, which will be described in more detail in the description that follows, are controlled by the processor P2 of the processing unit 210.

According to an exemplary embodiment, the modules DISC2 and COM21 are advantageously gathered together within a new protocol layer CP2 of the OSI model that is situated preferably between “transport” layer No. 4 and “session” layer No. 5.

In particular, in accordance with the invention, the new protocol layer of the terminal T1 is capable of conversing with the new protocol layer of the terminal T2, via the local area telecommunications network LAN1.

Moreover, the terminal T1 is adapted to, in accordance with the invention, also engage its wide area telecommunications network WAN1. To this end:
the discovery module DISC1 of the terminal T1 is adapted to implement the functionalities of the aforementioned discovery module DISC2,
the communication module COM11 of the terminal T1 is adapted to implement the functionalities of the aforementioned communication module COM21.

Correspondingly, the terminal T2 is adapted to, in accordance with the invention, request download of a content from the server SERV3. To this end, the terminal T2 is adapted to also include:
an interception module ICN2 capable of intercepting a content download request transmitted by the communication module COM20 of the terminal T2,
a determination module DET2 capable of determining at least one data segment of the content to be downloaded,
a module AGR2 for aggregating content data segments.

Moreover:
the discovery module DISC2 of the terminal T2 is adapted to implement the functionalities of the aforementioned discovery module DISC1,
the communication module COM21 of the terminal T2 is adapted to implement the functionalities of the aforementioned communication module COM11.

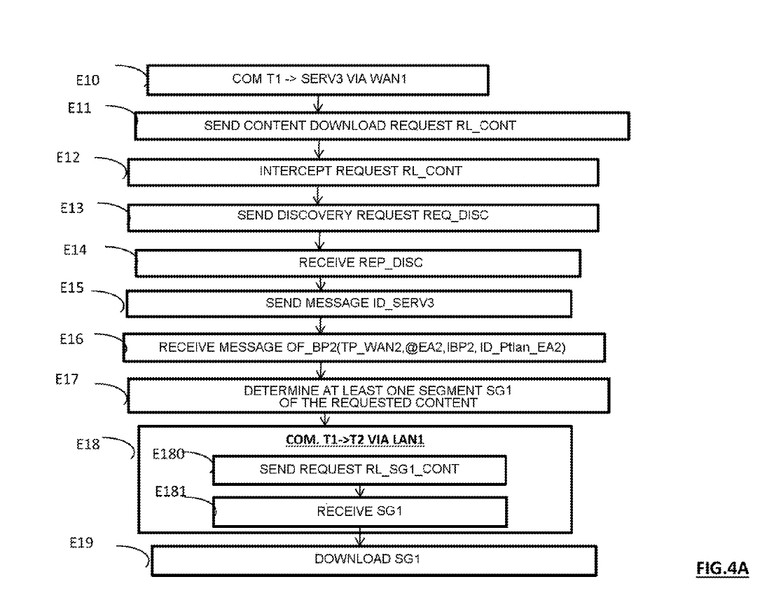

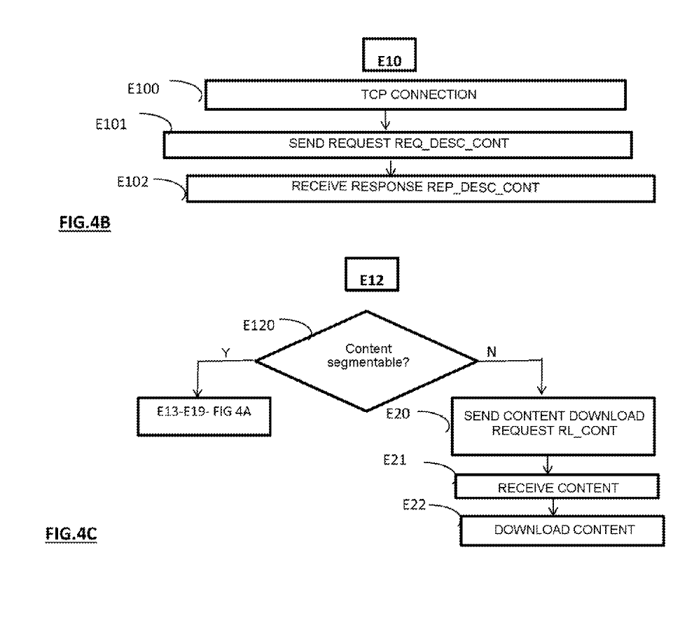

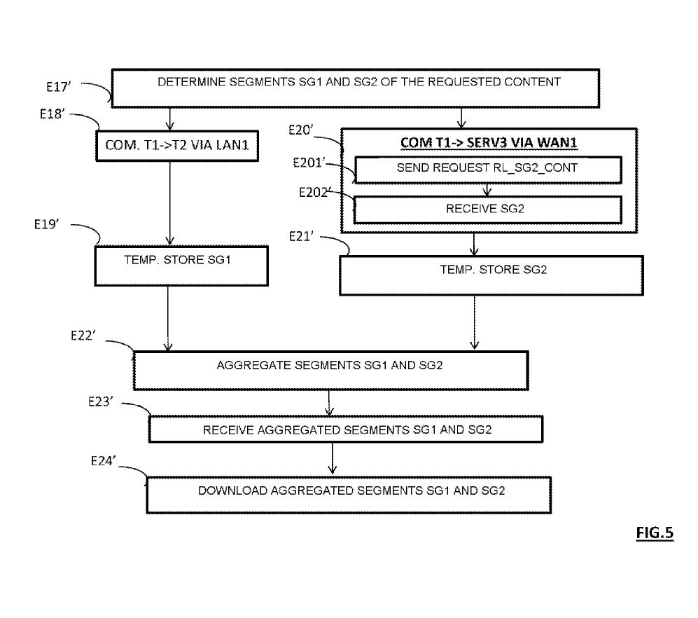

In connection with FIG. 4A, the steps of the method for downloading content according to a first embodiment according to the invention will now be presented. In this first represented embodiment, said download method is implemented by the terminal T1 represented in FIGS. 1 and 2.

In the course of a step E10 represented in FIG. 4A, the communication module COM10 of the terminal T1 sets up a communication with the server SERV3 of FIG. 1, via the wide area telecommunications network WAN1.

An example of such setup of a communication is represented in FIG. 4B.

Step E10 consists, by way of example, in:
setting up, in the course of a substep E100, a connection according to the predetermined protocol TCP, to the server SERV3,
transmitting, in the course of a sub step E101, to the content server SERV3, a download request REQ_DESC_CONT for descriptive information relating to a content that the terminal T1 wishes to download,
receiving from the server SERV3, in the course of a sub step E102, a response message REP_DESC_CONT that contains said descriptive information.

By way of example, descriptive information of this kind presents itself in the form of one or more intermediate descriptive files, also called documents, or manifests, or even resources, containing the addresses of a plurality of segments making up a content under consideration, in association with the various coding profiles attributed to each segment.

Once communication has been set up in accordance with the aforementioned step E10, in the course of a step E11 represented in FIG. 4A, the communication module COM10 of the terminal T1 transmits to the server SERV3, via the wide area telecommunications network WAN1, a content download request RL_CONT.

Step E11 consists in requesting download of the content in its entirety if the content is not segmentable or even in requesting one or more segments of this content, if the content is segmentable.

In the course of a step E12 represented in FIG. 4A, the module ITN1 of the terminal T1 intercepts the content download request RL_CONT, for the purpose of analyzing the requested type of content. An implementation example of the interception step E12 will be described later on in the description with reference to FIG. 4C.

In the course of a step E13 represented in FIG. 4A, if the analyzed content is segmentable, the discovery module DISC1 of the terminal T1 transmits, in the local area telecommunications network LAN1, a discovery request REQ_DISC for one or more terminals likely to be connected to the terminal T1.

In the course of a step E14 represented in FIG. 4A, if the terminal T2 is connected to the local area network LAN1, the discovery module DISC1 of the terminal T1 receives from the corresponding discovery module DISC2 of the terminal T2, via the local area network LAN1, a response REP_DISC indicating to the terminal T1 that the terminal T2 is connected to the local area network LAN1.

In the course of a step E15 represented in FIG. 4A, the module COM11 of the terminal T1 sends to the terminal T2, via the local area network LAN1, a message ID_SERV3 that contains identification information for the server SERV3. By way of example, such identification information is the IP address of the server SERV3, denoted by @SERV3, and the identifier of the port of the latter, denoted by ID_PT_SERV3.

If, at the end of a predetermined time, the terminal T1 receives no response from the terminal T2, the discovery procedure for the terminal T2 is ended.

Otherwise, in the course of a step E16 represented in FIG. 4A, the module COM11 of the terminal T1 receives from the terminal T2, via the local area network LAN1, a message OF_BP2 offering to share the wide area telecommunications network WAN2 to which the terminal T2 is connected, for the purpose of downloading the requested content. The message OF-BP2 particularly contains:
the type TP_WAN2 to which the wide area network WAN2 belongs, “3G” in the example represented in FIG. 1,
the IP address @EA2 of the gateway EA2 of the terminal T2 in the wide area network WAN2,
the bandwidth BP2 offered by the terminal T2, that is to say the downlink bandwidth capacity available on the line of the gateway EA2,
an identifier ID_PTlan_EA2 of the port of the gateway EA2 of the terminal T2 in the local area network LAN1.

If the terminal T2 is incapable of sharing its wide area telecommunications network WAN2, according to an embodiment that is not represented, then the module COM11 of the terminal T1 receives from the terminal T2, via the local area network LAN1, an invalidation message for the sharing.

According to an alternative embodiment, step E16 is implemented before step E15.

Moreover, it will be understood that the invention can be implemented just as well in PULL mode as in PUSH mode.

In PULL mode, the module COM11 of the terminal T1 explicitly requests from the terminal T2 an offer to share the wide area network WAN2 to which the terminal T2 is connected. The message OF_BP2 is thus received in the course of the aforementioned step E16, in response to the explicit request from the terminal T1.

In PUSH mode, the message OF_BP2 is received in the course of the aforementioned step E16, spontaneously from the terminal T2. By way of example, the PUSH mode is implemented when the bandwidth BP2 available on the wide area network WAN2 to which the terminal T2 is connected is not used in its entirety.

Of course, if multiple terminals are discovered by the terminal T1, then a combination of these two modes can advantageously be implemented, a message offering to share from a discovered first terminal being spontaneously received by the module COM11 of the terminal T1, and another message offering to share from a discovered second terminal being received in response to an explicit request from the module COM11 of the terminal T1.

In the course of a step E17 represented in FIG. 4A, the module DET1 of the terminal T1 determines at least one data segment SG1 of the content to be downloaded on the basis of the information mentioned in the received message offering to share OF_BP2.

Such a determination step is implemented, by way of example:
on the basis of the descriptive information relating to the content that the terminal T1 wishes to download and that is contained in the message REP_DESC_CONT that the terminal T1 has received in the course of the aforementioned step E10,
and on the basis of the evaluation of the quantity of bandwidth BP1 that the terminal T1 has locally.

In the course of a step E18 represented in FIG. 4A, the module COM11 of the terminal T1 sets up a communication with the terminal T2, according to the predetermined communication protocol TCP, via the local area network LAN1.

To this end, in the course of a sub step E180 represented in FIG. 4A, the module COM11 of the terminal T1 transmits, via the local area network LAN1, to the port of the gateway EA2 of the terminal T2 that is associated with the previously received identifier ID_PTlan_EA2, a download request RL_SG1_CONT for the determined first segment SG1. By way of example, such a request contains the URL address for accessing the segment SG1, as contained in the descriptive file for the content to be downloaded that is present in the message REP_DESC_CONT that the terminal T1 has received in the course of the aforementioned step E10.

In the course of a sub step E181 represented in FIG. 4A, the module COM11 of the terminal T1 receives from the terminal T2, via the local area network LAN1, the first segment SG1. The first segment SG1 has been obtained previously by the terminal T2, in response to a request transmitted by the latter to the server SERV3, via its wide area network WAN2. Said request particularly contains:
the IP address @SERV3 of the server SERV3,
the identifier ID_PT_SERV3 of the port of the server SERV3,
the IP address @EA2 of the gateway EA2 of the terminal T2 in the wide area network WAN2,
an identifier ID_PTwan_EA2 of the port of the gateway EA2 of the terminal T2 in the wide area network WAN2.

In the course of a step E19 represented in FIG. 4A, the received segment SG1 is downloaded into the module TEL1 of the terminal T1.

There will now be a description, in connection with FIG. 4C, of an example of step E12 of intercepting a content download request RL_CONT.

Interception step E12 consists in:
determining, in the course of a sub step E120, whether the content to be downloaded can be broken down into at least one first data segment SG1,
if the response is positive, implementing the aforementioned steps E13 to E19,
if the response is negative,
   continuing, in the course of a step E20, to transmit the content download request RL_CONT to the server SERV3, via the wide area telecommunications network WAN1,
   receiving, in the course of a step E21, the content from the server SERV3,
   downloading, in the course of a step E22, the content received in the module TEL1 of the terminal T1.

Segmentable content is understood to mean a content downloadable via the wide area network WAN1 or the wide area network WAN2:
either by temporal data segment,
or by “byte range” (identified portion of bytes),
or by layer in accordance with SVC (“Scalable Video Codec) technology, for example.

These three download methods can be used just as well for a previously coded VOD content as for a content broadcast live, that is to say coded and segmented on the fly.

In connection with FIG. 5, a method for downloading content in accordance with a second embodiment according to the invention will now be presented. In this second embodiment that is represented, said download method is still implemented by the terminal T1 represented in FIGS. 1 and 2.

This second embodiment is identical to the first embodiment of FIG. 4A up to step E16. Therefore, steps E10 to E16 will not be represented again in FIG. 5. In this second embodiment, step E17 is replaced by step E17′ of FIG. 5, in the course of which the module DET1 of the terminal T1 determines, in addition to the aforementioned first segment SG1, a second content segment SG2 to be downloaded, this second segment SG2 being able to be requested directly by the terminal T1 from the server SERV3.

In the course of a step E18′ represented in FIG. 5, the module COM11 of the terminal T1 sets up a communication with the terminal T2, according to the predetermined communication protocol TCP, via the local area network LAN1, for the purpose of receiving the first data segment SG1. As step E18′ is identical to step E18 of the FIG. 4A, it will not be described below.

In the course of a step E19′ represented in FIG. 5, the module COM11 of the terminal T1 transmits the received segment SG1 to the temporary storage memory MST1 of the terminal T1 that is represented in FIG. 1.

In the course of a step E20′ represented in FIG. 5, the module COM10 of the terminal T1 sets up a communication directly with the server SERV3, according to the predetermined communication protocol TCP, via the wide area network WAN1, for the purpose of receiving the first data segment SG1.

To this end, in the course of a sub step E201′ represented in FIG. 5, the module COM10 of the terminal T1 conventionally transmits, via the wide area network WAN1, to the server SERV3, a download request RL_SG2_CONT for the determined second segment SG2. By way of example, such a request contains the URL address for accessing the segment SG2, as contained in the descriptive file for the content to be downloaded that is present in the message REP_DESC_CONT that the terminal T1 has received in the course of the aforementioned step E10.

In the course of a sub step E202′ represented in FIG. 5, the module COM10 of the terminal T1 receives from the server SERV3, via the wide area network WAN1, the requested second segment SG2.

In the course of a step E21′ represented in FIG. 5, the module COM10 of the terminal T1 transmits the received second segment SG2 to the temporary storage memory MST1 of the terminal T1 that is represented in FIG. 1.

In the example that is represented, the set of steps E18′ and E19′ is implemented in parallel with the set of steps E20′ and E21′.

As a variant, the set of steps E18′ and E19′ could be implemented before or after the set of steps E20′ and E21′.

In the course of a step E22′ represented in FIG. 5, the module AGR1 of the terminal T1 aggregates the first segment SG1 and the second segment SG2 in a predetermined order, for example in accordance with their order of appearance in the content.

In the course of a step E23′ represented in FIG. 5, the module AGR1 of the terminal T1 transmits the segments SG1 and SG2 aggregated in this manner to the communication module COM10 of the terminal T1, which receives them as a response to the content download request RL_CONT transmitted in the course of step E10 of FIG. 4A.

In the course of a step E24′ represented in FIG. 5, the received aggregated segments SG1 and SG2 are downloaded into the module TEL1 of the terminal T1.

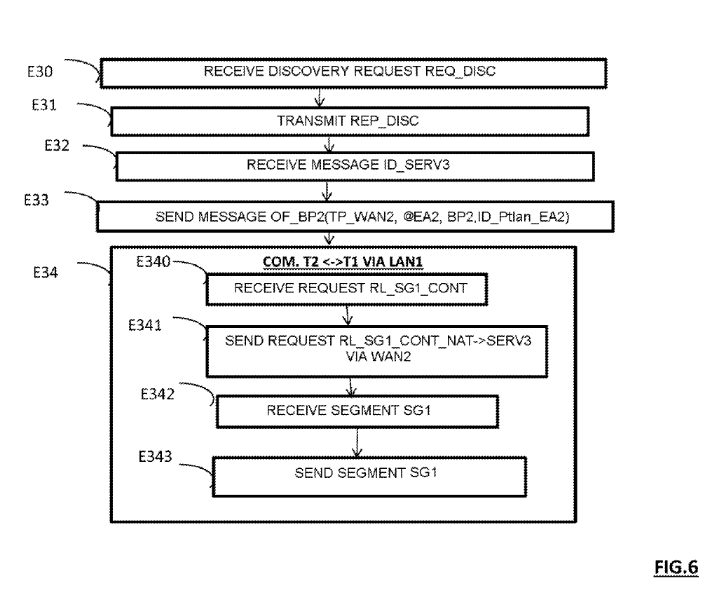

In connection with FIG. 6, the steps of the method for providing a wide area telecommunications network in accordance with an embodiment according to the invention will now be presented. In this embodiment, that is represented, said provision method is implemented by the terminal T2 represented in FIGS. 1 and 3.

The aim of such a method is that the terminal T2 provides its wide area network WAN2 for the terminal T1, so that the latter can download a content from the server SERV3.

To this end, in the course of a step E30 represented in FIG. 6, if the content to be downloaded is segmentable as has been described earlier on in the description, the discovery module DISC2 of the terminal T2 receives, in the local area telecommunications network LAN1, from the terminal T1, a discovery request REQ_DISC for one or more terminals likely to be connected to the terminal T1.

In the course of a step E31 represented in FIG. 6, if the terminal T2 is actually connected to the local area network LAN1, then the discovery module DISC2 of the terminal T2 sends to the corresponding discovery module DISC1 of the terminal T1, via the local area network LAN1, a response REP_DISC indicating to the terminal T1 that the terminal T2 is connected to the local area network LAN1.

In the course of a step E32 represented in FIG. 6, the module COM21 of the terminal T2 receives from the terminal T1, via the local area network LAN1, a message ID_SERV3 that contains identification information for the server SERV3. By way of example, such identification information is the IP address of the server SERV3, denoted by @SERV3, and the identifier of the port of the latter, denoted by ID_PT_SERV3.

In the course of a step E33 represented in FIG. 6, the module COM21 of the terminal T2 transmits to the terminal T1, via the local area network LAN1, a message OF_BP2 offering to share the wide area telecommunications network WAN2 to which the terminal T2 is connected, for the purpose of downloading the content requested by the terminal T1. The message OF_BP2 particularly contains:
the type TP_WAN2 to which the wide area network WAN2 belongs, “3G” in the example represented in FIG. 1,
the IP address @EA2 of the gateway EA2 of the terminal T2 in the wide area network WAN2,
the bandwidth BP2 offered by the terminal T2, that is to say the downlink bandwidth capacity available on the line of the gateway EA2,
an identifier ID_PTlan_EA2 of the port of the gateway EA2 of the terminal T2 in the local area network LAN1.

If the terminal T2 is incapable of sharing its wide area telecommunications network WAN2, according to an embodiment that is not represented, the module COM21 of the terminal T2 sends to the terminal T2, via the local area network LAN1, an invalidation message for the sharing.

According to an alternative embodiment, step E33 is implemented before step E32.

In a manner corresponding to the method for downloading content described in FIG. 4A, the method for providing a wide area network can be implemented just as well in PULL mode as in PUSH mode.

In PULL mode, in the course of the aforementioned step E33, the module COM21 of the terminal T2 sends the message OF_BP2 to the terminal T1, in response to an explicit request from the terminal T1.

In PUSH mode, in the course of the aforementioned step E33, the module COM21 of the terminal T2 spontaneously sends the message OF_BP2 to the terminal T1, for example if the terminal T2 determines that the bandwidth BP2 available on its wide area network WAN2 is not used in its entirety.

In the course of a step E34 represented in FIG. 6, a communication according to the predetermined communication protocol TCP is set up between the module COM21 of the terminal T2 and the communication module COM11 of the terminal T1, via the local area network LAN1.

To this end, in the course of a sub step E340 represented in FIG. 6, the terminal T2 receives from the terminal T1, via the local area network LAN1, on the port of the gateway EA2 of the terminal T2 that is associated with the identifier ID_PTlan_EA2 previously sent to the terminal T1, a download request RL_SG1_CONT for the first content segment SG1. By way of example, such a request contains the URL address for accessing the segment SG1, as contained in the descriptive file for the content to be downloaded that is present in the message REP_DESC_CONT that the terminal T1 has received in the course of step E10 described with reference to FIGS. 4A and 4B.

In the course of a sub step E341 represented in FIG. 6, the module COM20 of the terminal T2 retransmits the request RL_SG1_CONT to the server SERV3, via the wide area network WAN2 of the terminal T2, in the form of a request RL_SG1_CONT_NAT that particularly contains:
the IP address @SERV3 of the server SERV3,
the identifier ID_PT_SERV3 of the port of the server SERV3,
the IP address @EA2 of the gateway EA2 of the terminal T2 in the wide area network WAN2,
an identifier ID_PTwan_EA2 of the port of the gateway EA2 of the terminal T2 in the wide area network WAN2.

In the course of a sub step E342 represented in FIG. 6, the module COM20 of the terminal T2 receives the first segment SG1 from the server SERV3, via the wide area network WAN2.

In the course of a sub step E343 represented in FIG. 6, the module COM21 of the terminal T2 returns the segment SG1 to the terminal T1, via the local area network LAN1, in response to the download request RL_SG1_CONT for the first segment SG1 that has been received in the aforementioned sub step E340.

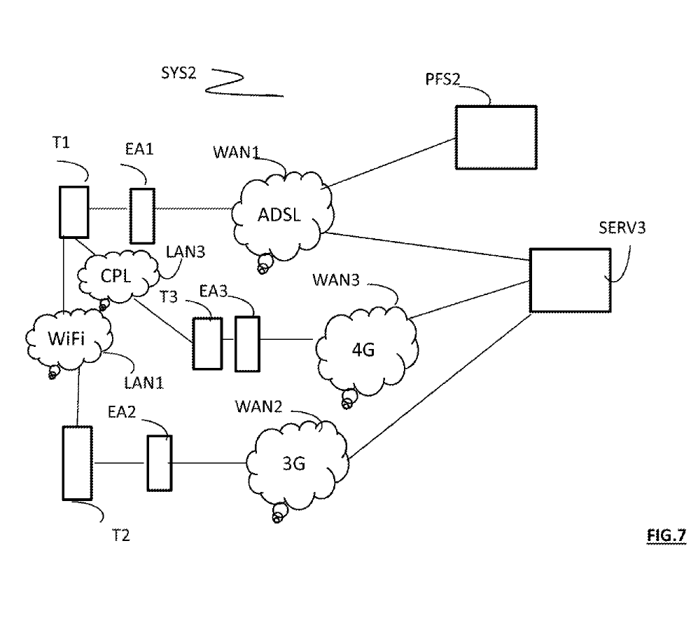

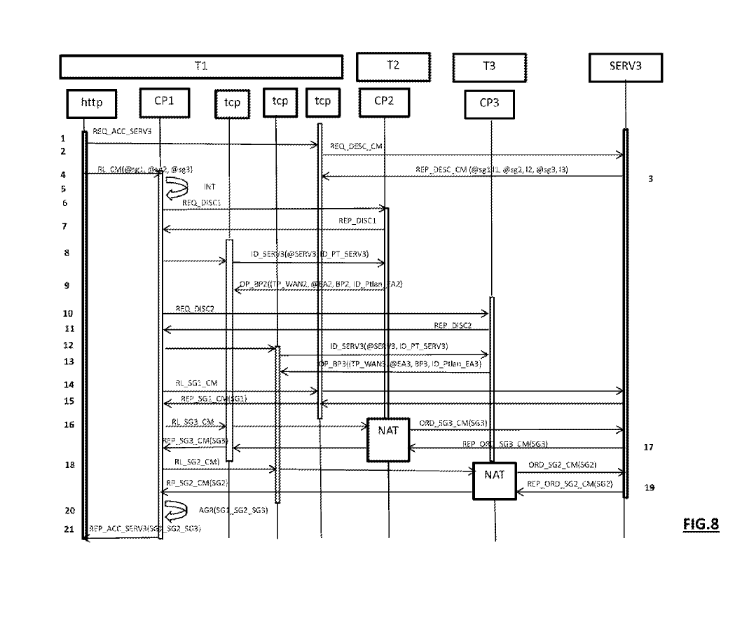

With reference to FIGS. 7 and 8, an example of an instance of use of the invention will be presented.

In connection with FIG. 7, an architecture SYS2 that is similar to the architecture SYS1 of FIG. 1 and that is distinguished from the latter by the presence of a third terminal T3 to which the terminal T1 is connected, via a local area telecommunications network LAN2, for example of powerline type, will be presented. The terminal T3, for its part, is adapted to communicate with the server SERV3 via a third wide area telecommunications network WAN3, such as for example of IP type. In the example that is represented, the network WAN3 is of mobile and more particularly 4G type. The terminal T3 is connected to the network WAN3 by means of an access device EA3, such as a home or company gateway, for example.

The terminal T3 has exactly the same structure as the terminal T2. For this reason, it will not be described below.

In connection with FIG. 8, the instance of use according to the invention is the download, into the terminal T1 of FIG. 7, of a multimedia content CM broadcast live of separable type, that is to say prepared for being separable into multiple segments that are available simultaneously at multiple multicast addresses.

By way of example, what is involved is a stream coded hierarchically, for example according to a scalable format, of MPEG-4 SVC type, comprising a first layer of data called a base layer and at least one second layer of data called an enhancement layer. The first layer can advantageously be broadcast from a first multicast address, the enhancement layer(s) being broadcast at other multicast addresses.

Another known way of making a stream separable is to separate the substreams that constitute it, for example to broadcast the video sub stream at a first multicast address and the audio substream and/or the subtitle sub streams at a second multicast address.

Yet another way of making a stream separable is to use a data partitioning technique to distribute the coded data between multiple multicast broadcast sources.

According to the instance of use that is represented, it is assumed that the terminal T2 and the terminal T3 are capable of sharing their respective wide area telecommunications network with the terminal T1.

At 1, the terminal T1 sends an access request REQ_ACC_SERV3 to the server SERV3. The request REQ_ACC_SERV3 is a conventional http request that contains the address @SERV3 of the server SERV3 and the identifier ID_PT_SERV3 of the port of the server SERV3.

At 2, the application part of the protocol overlayer between http and tcp of the terminal T1 then requests setup of a first communication session according to the TCP protocol in order to converse with the server SERV3. During this communication, the terminal T1 conventionally transmits a request REQ_DESC_CM for descriptive information for the separable content CM to the server SERV3. It is assumed that the content CM is separable into three segments SG1, SG2 and SG3, each being available at a different multicast address.

At 3, the server SERV3 sends a response REP_DESC_CM to the terminal T1 that contains multiple URLs @sg1, @sg2 and @sg3 for accessing the content CM, corresponding to the various multicast source addresses @sg1, @sg2 and @sg3 of the various segments SG1, SG2 and SG3 of the content CM and information relating to a downlink bandwidth 11, 12, 13 that is necessary in order to receive each of these segments.

At 4, the terminal T1 transmits an http download request RL_CM for the content CM, using the open TCP session. The request RL_CM contains the various aforementioned multicast source addresses @sg1, @sg2 and @sg3.

At 5, in accordance with the invention, the request RL_CM is intercepted by the new protocol layer CP1 of the terminal T1. The layer CP1 then determines that the request RL_CONT can be subdivided into multiple independent requests for access to the segments SG1, SG2 and SG3 of the content CM.

At 6, in accordance with the invention, the layer CP1 of the terminal T1 transmits a discovery request REQ_DISC1 for terminals connected to the local area network LAN1 of FIG. 7.

At 7, the layer CP1 of the terminal T1 receives a response REP_DISC1 indicating that the terminal T2 is connected to the local area network LAN1.

At 8, in accordance with the invention, the layer CP1 then requests setup of a second communication session according to the TCP protocol in order to converse with the terminal T2. During this second communication session, the terminal T1 transmits to the terminal T2, via the local area network LAN1, a message ID_SERV3 that contains the address @SERV3 of the server SERV3 and the identifier ID_PT_SERV3 of the port of the server SERV3.

At 9, the terminal T1 obtains in response from the terminal T2, via the network LAN1, a message OF_BP2 offering to share the wide area telecommunications network WAN2 to which the terminal T2 is connected. The message OF_BP2 particularly contains:
the type TP_WAN2 to which the wide area network WAN2 belongs, “3G” in the example represented in FIG. 7,
the IP address @EA2 of the gateway EA2 of the terminal T2 in the wide area network WAN2,
the bandwidth BP2 offered by the terminal T2, that is to say the downlink bandwidth capacity available on the line of the gateway EA2,
an identifier ID_PTlan_EA2 of the port of the gateway EA2 of the terminal T2 in the local area network LAN1.

At 10, in accordance with the invention, the layer CP1 of the terminal T1 sends a discovery request REQ_DISC2 for terminals connected to the local area network LAN2 of FIG. 7.

At 11, the layer CP1 of the terminal T1 receives a response REP_DISC2 indicating that the terminal T3 is connected to the local area network LAN2.

At 12, in accordance with the invention, the layer CP1 then requests setup of a third communication session according to the TCP protocol in order to converse with the terminal T3. During this third communication session, the terminal T1 transmits to the terminal T3, via the local area network LAN2, a message ID_SERV3 that contains the address @SERV3 of the server SERV3 and the identifier ID_PT_SERV3 of the port of the server SERV3.

At 13, the terminal T1 obtains in response from the terminal T3, via the network LAN2, a message OF_BP3 offering to share the wide area telecommunications network WAN3 to which the terminal T3 is connected. The message OF_BP3 particularly contains:
the type TP_WAN3 to which the wide area network WAN3 belongs, “4G” in the example represented in FIG. 7,
the IP address @EA3 of the gateway EA3 of the terminal T3 in the wide area network WAN3,
the bandwidth BP3 offered by the terminal T3, that is to say the downlink bandwidth capacity available on the line of the gateway EA3,
an identifier ID_PTlan_EA3 of the port of the gateway EA3 of the terminal T3 in the local area network LAN2.

In accordance with the invention, the layer CP1 of the terminal T1 then determines what segments of the content CM the terminal T1 will control on the terminals T2 and T3.

In the example that is represented, the layer CP1 determines that the terminal T1:
requests the first segment SG1 directly from the server SERV3,
requests the second segment SG2 from the third terminal T3,
requests the third segment SG3 from the second terminal T2.

At 14, the layer CP1 of the terminal T1 sends to the server SERV3 a conventional http download request RL_SG1_CM for the segment SG1 according to the TCP protocol used for the aforementioned first communication session, said request containing the address @sg1 associated with the segment SG1.

At 15, the layer CP1 of the terminal T1 receives from the server SERV3 a response REP_SG1_CM that contains the segment SG1.

At 16, in accordance with the invention, the layer CP1 of the terminal T1 sends to the terminal T2 an http download request RL_SG3_CM for the segment SG3, according to the TCP protocol used for the aforementioned first communication session. The request RL_SG3_CM contains:
the address @sg3 associated with the segment SG3,
the IP address @EA1_LAN1 of the gateway EA1 of the terminal T1 in the local area network LAN1,
an identifier ID_Ptlan1_EA1 of the port of the gateway EA1 of the terminal T1 in the local area network LAN1,
the IP address @EA2_LAN of the gateway EA2 of the terminal T2 in the local area network LAN1,
the identifier ID_Ptlan_EA2 of the port of the gateway EA2 of the terminal T2 in the local area network LAN1.

The terminal T2 then routes the request RL_SG3_CM to the server SERV3 by carrying out an address translation NAT. To this end, the terminal T2 sends to the server SERV3 a download request ORD_SG3_CM for the segment SG3, which contains:
the address @sg3 associated with the segment SG3,
the IP address @EA2 of the gateway EA2 of the terminal T2 in the wide area network WAN2,
an identifier ID_Ptwan_EA2 of the port of the gateway EA2 of the terminal T2 in the wide area network WAN2,
the IP address @SERV3 of the server SERV3,
the identifier ID_PT_SERV3 of the port of the server SERV3.

At 17, in accordance with the invention, the server SERV3 sends in response to the terminal T2 a response REP_ORD_SG3_CM that contains:
the segment SG3,
the IP address @SERV3 of the server SERV3,
the identifier ID_PT_SERV3 of the port of the server SERV3,
the IP address @EA2 of the gateway EA2 of the terminal T2 in the wide area network WAN2,
the identifier ID_Ptwan_EA2 of the port of the gateway EA2 of the terminal T2 in the wide area network WAN2.

The terminal T2 then routes the response REP_ORD_SG3_CM to the layer CP1 of the terminal T1 by carrying out an address translation NAT. To this end, the terminal T2 sends to the terminal T1 a response REP_SG3_CM that contains:
the segment SG3,
the IP address @EA2_LAN of the gateway EA2 of the terminal T2 in the local area network LAN1,
the identifier ID_Ptlan_EA2 of the port of the gateway EA2 of the terminal T2 in the local area network LAN1,
the IP address @EA1_LAN1 of the gateway EA1 of the terminal T1 in the local area network LAN1,
the identifier ID_Ptlan1-EA1 of the port of the gateway EA1 of the terminal T1 in the local area network LAN1.

At 18, in accordance with the invention, the layer CP1 of the terminal T1 sends to the terminal T3 an http download request RL_SG2_CM for the segment SG2, according to the TCP protocol used for the aforementioned third communication session. The request RL_SG2_CM contains:
the address @sg2 associated with the segment SG2,
the IP address @EA1_LAN2 of the gateway EA1 of the terminal T1 in the local area network LAN2,
an identifier ID_Ptlan2_EA1 of the port of the gateway EA1 of the terminal T1 in the local area network LAN2,
the IP address @EA3_LAN of the gateway EA3 of the terminal T3 in the local area network LAN2,
the identifier ID_Ptlan_EA3 of the port of the gateway EA3 of the terminal T3 in the local area network LAN2.

The terminal T3 then routes the request RL_SG2_CM to the server SERV3 by carrying out an address translation NAT. To this end, the terminal T3 sends to the server SERV3 a download request ORD_SG2_CM for the segment SG2, which request contains:
the address @sg2 associated with the segment SG2,
the IP address @EA3 of the gateway EA3 of the terminal T3 in the wide area network WAN3,
an identifier ID_Ptwan_EA3 of the port of the gateway EA3 of the terminal T3 in the wide area network WAN3,
the IP address @SERV3 of the server SERV3,
the identifier ID_PT_SERV3 of the port of the server SERV3.

At 19, in accordance with the invention, the server SERV3 sends to the terminal T3 a response REP_ORD_SG2_CM that contains:
the segment SG2,
the IP address @SERV3 of the server SERV3,
the identifier ID_PT_SERV3 of the port of the server SERV3,
the IP address @EA3 of the gateway EA3 of the terminal T3 in the wide area network WAN3,
the identifier ID_Ptwan_EA3 of the port of the gateway EA3 of the terminal T3 in the wide area network WAN3.

The terminal T3 then routes the response REP_ORD_SG2_CM to the layer CP1 of the terminal T1 by carrying out an address translation NAT. To this end, the terminal T3 sends to the terminal T1 a response REP_SG2_CM that contains:
the segment SG2,
the IP address @EA3_LAN of the gateway EA3 of the terminal T3 in the local area network LAN2,
the identifier ID_Ptlan_EA3 of the port of the gateway EA3 of the terminal T3 in the local area network LAN2,
the IP address @EA1_LAN2 of the gateway EA1 of the terminal T1 in the local area network LAN2,
the identifier ID_Ptlan2_EA1 of the port of the gateway EA1 of the terminal T1 in the local area network LAN2.

In the example that is represented, the set of steps 14 and 15, the set of steps 16 and 17 and the set of steps 18 and 19 are implemented in parallel.

As a variant, the set of steps 14 and 15, the set of steps 16 and 17 and the set of steps 18 and 19 are implemented successively in any order.

At 20, in accordance with the invention, the layer CP1 aggregates the three segments SG1, SG2, SG3 received in a preestablished order that is, for example, the order of appearance of the segments in the content CM: SG1, SG2, SG3.

At 21, in accordance with the invention, the layer CP1 of the terminal T1 sends, to the application part of the protocol overlayer between http and tcp of the terminal T1 that has transmitted, at 1, the initial http request REQ_ACC_SERV3, a response REP_ACC_SERV3 that contains the aggregated segments SG1_SG2_SG3 of the requested content CM.

The invention thus allows pooling of the bandwidths from which multiple neighboring subscribers benefit in order to facilitate access to segmentable digital content available on the Internet network.

The invention is particularly advantageous in that it does not involve any particular modification of the server SERV3 and of the infrastructure of the local area networks LAN1, LAN2 and wide area networks WAN1, WAN2 and WAN3.

It goes without saying that the embodiments that have been described above have been provided purely by way of indication and without any limitation, and that numerous modifications can easily be made by a person skilled in the art without, however, departing from the scope of the invention.

1. A method for downloading content into a first terminal from a server via a first wide area telecommunications network, said method comprising:
setting up a first communication from the first terminal, according to a predetermined communication protocol, in the course of which the first terminal transmits a download request for a content to said server, via said first wide area telecommunications network;
intercepting, by said first terminal, said content download request;
discovering, by said first terminal, at least one second terminal connected to the first terminal via a local area telecommunications network, the second terminal being moreover-connected to a second wide area telecommunications network, in the course of which the first terminal:
sends to the second terminal a message that contains identification information for the server;
receives from the second terminal a message offering to share the second wide area telecommunications network, for the purpose of said content download, the message offering to share containing a port identifier associated with the second terminal;
determining by said first terminal, at least one first data segment of the content to be downloaded on the basis of the offer to share contained in the received message;
setting up, by said first terminal, a second communication from the first terminal, according to said predetermined communication protocol, in the course of which the first terminal, via said local area telecommunications network:
transmits to the port associated with the second terminal a download request for the determined first content segment; and
receives from the second terminal the first content segment that has been obtained previously by the second terminal following a connection by the latter to said server, via the second wide area telecommunications network, using the identification information for the server that was sent by the first terminal in the discovery process.

2. The download method as claimed in claim 1, wherein the message offering to share received in the discovery process further contains:
the type to which the second wide area telecommunications network belongs;
the address of a device for the second terminal to access the second wide area telecommunications network; and
the bandwidth offered by the second terminal.

3. The download method as claimed in claim 1, wherein the process-of intercepting the download request comprises:
determining whether the content to be downloaded can be broken down into at least one first data segment;
in the event of the response being positive, transmitting a discovery request from one or more connected terminals to the first terminal via the local area telecommunications network;
in the event of the response being negative:
continuing transmission of the content download request to said server; and
receiving the content from the server.

4. The download method as claimed in claim 1, wherein, in the event of the first terminal determining that the content to be downloaded comprises a second data segment and that the bandwidth of the first terminal is sufficient to allow download of the second segment directly from the server, the following processes are performed:
setting up a third communication from the first terminal, according to said predetermined communication protocol, in the course of which the first terminal, via said first wide area telecommunications network:
transmits to the server a download request for the second content segment; and
receives the second content segment from the server.

5. The download method as claimed in claim 4, wherein, following reception of the first and second segments, the following processes are performed, on the first terminal:
aggregating the first and second segments in a predetermined order; and
receiving the aggregated first and second segments in response to said download request for a content, transmitted in the course of said first communication set up by the first terminal.

6. The download method as claimed in claim 1, further comprising the following processes:
discovering at least one third terminal connected to the first terminal via said local area telecommunications network, the third terminal being connected to a third wide area telecommunications network, in the course of which the first terminal:
sends to the third terminal a message that contains identification information for the server;
receives from the third terminal a message offering to share the third wide area communication network, for the purpose of said content download, the message containing a port identifier associated with the third terminal;
determining at least one third data segment of the content to be downloaded on the basis of the offer to share contained in the received message;
setting up a fourth communication from the first terminal, according to said predetermined communication protocol, in the course of which the first terminal, via said local area telecommunications network:
transmits to the port associated with the third terminal a download request for the determined third content segment; and
receives from the third terminal the third content segment, which has been obtained previously by the third terminal following a connection by the latter to said server, via the third wide area telecommunications network, by using the identification information for the server that was sent by the first terminal in the discovery process.

7. The download method as claimed in claim 6, wherein, following reception either of the first and third segments or of the first, second and third segments, the following processes are performed, on the first terminal:
aggregating the first, second and third segments in a predetermined order; and
receiving the aggregated first, second and third segments, in response to said download request for a content, transmitted in the course of said first communication set up by the first terminal.

8. A first terminal configured to download content from a server, via a first wide area telecommunications network, and to set up a first communication according to a predetermined communication protocol that is adapted to transmit a download request for a content to said server, via said first wide area telecommunications network,
said first terminal being further configured to:
intercept the content download request;
discover at least one second terminal connected firstly to the first terminal via a local area telecommunications network and, secondly, to a second wide area telecommunications network by:
sending to the second terminal a message that contains identification information for the server;
receiving from the second terminal a message offering to share the second wide area telecommunications network, for the purpose of said content download, the message offering to share containing a port identifier associated with the second terminal;
determine at least one first data segment of the content to be downloaded on the basis of the offer to share contained in the received message;
set up a second communication from the first terminal, according to said predetermined communication protocol, via the local area telecommunications network by:
transmitting to the port associated with the second terminal a download request for the determined first content segment; and
receiving from the second terminal the first content segment that has been obtained previously by the second terminal following a connection by the latter to said server, via the second wide area telecommunications network, using the identification information for the server that was sent by the first terminal.

9. A non-transitory computer readable medium having stored thereon instructions for executing a downloading method when said instructions are executed by a computer, wherein said downloading method is a method for downloading content into a first terminal from a server via a first wide area telecommunications network, said method comprising:
setting up a first communication from the first terminal, according to a predetermined communication protocol, in the course of which the first terminal transmits a download request for a content to said server, via said first wide area telecommunications network;
intercepting, by said first terminal, said content download request;
discovering, by said first terminal, at least one second terminal connected to the first terminal via a local area telecommunications network, the second terminal being connected to a second wide area telecommunications network, in the course of which the first terminal:
sends to the second terminal a message that contains identification information for the server; and
receives from the second terminal a message offering to share the second wide area telecommunications network, for the purpose of said content download, the message offering to share containing a port identifier associated with the second terminal;
determining, by said first terminal, at least one first data segment of the content to be downloaded on the basis of the offer to share contained in the received message;
setting up, by said first terminal, a second communication from the first terminal, according to said predetermined communication protocol, in the course of which the first terminal, via said local area telecommunications network:
transmits to the port associated with the second terminal a download request for the determined first content segment; and
receives from the second terminal the first content segment that has been obtained previously by the second terminal following a connection by the latter to said server, via the second wide area telecommunications network, using the identification information for the server that was sent by the first terminal in the discovery process.

10. A method for providing a first terminal, connected to a first wide area telecommunications network, with a second wide area telecommunications network to which a second terminal is connected, for the purpose of downloading a content into the first terminal from a server, said method being the performed by the second terminal, said method comprising:
discovering a connection from the second terminal to the first terminal via a local area telecommunications network, wherein the second terminal:
receives, from the first terminal, a message containing identification information for the server;
transmits to the first terminal a response to said message that contains an offer to share the second wide area telecommunications network for the purpose of said content download, said response containing a port identifier associated with the second terminal;
setting up a communication between the first and second terminals, wherein the second terminal:
receives on said port, from the first terminal, via said local area telecommunications network, a download request for a first content segment determined beforehand by the first terminal from the offer to share;
takes the received identification information for the server as a basis for routing to the server, via the second wide area telecommunications network, the received download request for the first segment;
receives in response the first content segment from the server, via the second wide area telecommunications network; and
transmits the received first content segment to the first terminal, via the local area telecommunications network.

11. The provision method as claimed in claim 10, wherein the response containing the offer to share the second wide area telecommunications network moreover contains:
the type to which the second wide area telecommunications network belongs;
the address of a device for the second terminal to access the second wide area telecommunications network; and
the bandwidth offered by the second terminal.

12. A terminal configured to provide another terminal connected to a first wide area telecommunications network with a second wide area telecommunications network to which said terminal is connected, for the purpose of downloading a content into said other terminal from a server,
said terminal being further configured to:
discover a connection from the terminal to the other terminal, via a local area telecommunications network by:
receiving, from the other terminal, a discovery request for at least one terminal connected to the other terminal via a local area telecommunications network, said request containing identification information for the server; and
transmitting to the other terminal, via the local area telecommunications network, a response to said request that contains an offer to share the second wide area telecommunications network, for the purpose of said content download, the response containing a port identifier associated with said terminal;
set up a communication between the two terminals by:
receiving on the port of the terminal, from the other terminal, via the local area telecommunications network, a download request for a first content segment determined beforehand by the other terminal from the offer to share;
taking the received identification information for the server as a basis for routing to the server, via the second wide area telecommunications network, the received download request for the first segment;
receiving in response the first content segment from the server, via the second wide area telecommunications network; and
transmitting the received first content segment to the other terminal, via the local area telecommunications network.

13. A non-transitory computer readable medium having stored thereon instructions for performing a provision method when said instructions are executed by a computer, wherein said provision method is a method for providing a first terminal, connected to a first wide area telecommunications network, with a second wide area telecommunications network to which a second terminal is connected, for the purpose of downloading a content into the first terminal from a server, said method being the performed by the second terminal, said method comprising:
discovering a connection from the second terminal to the first terminal via a local area telecommunications network, wherein the second terminal:
receives, from the first terminal, a message containing identification information for the server; and
transmits to the first terminal a response to said message that contains an offer to share the second wide area telecommunications network for the purpose of said content download, said response containing a port identifier associated with the second terminal;
setting up a communication between the first and second terminals, wherein the second terminal:
receives on said port, from the first terminal, via said local area telecommunications network, a download request for a first content segment determined beforehand by the first terminal from the offer to share;
takes the received identification information for the server as a basis for routing to the server, via the second wide area telecommunications network, the received download request for the first segment;
receives in response the first content segment from the server, via the second wide area telecommunications network; and
transmits the received first content segment to the first terminal, via the local area telecommunications network.
